(19) United States
(12) Patent Application Publication
(10) Pub. No.: US 2001/0029443 A1
(43) Pub. Date: Oct. 11, 2001

(54) Machine translation system, machine translation method, and storage medium storing program for executing machine translation method

(75) Inventor: Tomohiro Miyahira, Yamato-shi (JP)

Correspondence Address: Farrokh Pourmirzaie, IBM Corporation, Intellectual Prorperty Law, 555 Bailey Avenue (J46/G4), San Jose, CA, 95141-1003, US

(73) Assignee: International Business Machines Corporation

(21) Appl. No.: 09/818,360

(22) Filed: Mar. 26, 2001

(30) Foreign Application Priority Data
Mar. 27, 2000 (JP) 2000-085551

(51) Int. Cl. G06F 17/28; G06F 17/27

(52) U.S. Cl. 704/7; 704/9; 704/4

(57) ABSTRACT

A first aspect of the present invention provides a machine translation system comprising: input means for inputting an original text in a first language to be translated; translation processing means for performing translation processing, including parsing, on the inputted original text and generating a translation in a second language; dictionary storage means for storing various dictionaries for use in said translation processing; and output means for outputting said translation; wherein said translation processing means creates new phrase structure rules by synthesizing related phrase structure rules during said parsing and generates said translation based on said new phrase structure rules. A second aspect of the present invention provides a machine translation method comprising the steps of: inputting an original text in a first language to be translated; performing translation processing, including parsing, on the inputted original text with reference to a given dictionary to generate a translation in a second language; and outputting said translation; wherein said translation processing step creates new phrase structure rules by synthesizing related phrase structure rules during said parsing and generates said translation based on said new phrase structure rules. A third aspect of the present invention provides a computer-readable program storage medium which stores a program for performing the machine translation method of the second aspect.

This application claims the foreign priority benefits under 35 U.S.C. §119 of Japanese application No. 2000-85551 filed on Mar. 27, 2000, which is incorporated herein by reference.

### BACKGROUND OF THE INVENTION

1. Field of the Invention

The present invention relates to a machine translation system. More particularly, it relates to a machine translation system that can properly translate compound words and parallel expressions that could not be handled heretofore, by synthesizing new phrase structure rules from a plurality of phrase structure rules.

2. Description of the Related Art

Generally, a machine translation system receives an original text in a source language (e.g., English), and then gets a translation in a target language (e.g., Japanese) by performing the following processes in order: sentence slicing for slicing the original text sentence by sentence, morphological analysis for breaking down each sliced sentence into words, parsing for organizing the sequence of words into a phrase structure tree, syntactic generation for generating a phrase structure tree in the target language from the phrase structure in the source language, and morphological generation for generating a translation from the phrase structure in the target language. Of these processes, the description below will focus on the parsing because the present invention is related to the parsing.

Many machine translation systems create phrase structure trees of input sentences during parsing by applying phrase structure rules for parsing phrase structures to the input sentences. Suppose, for example, an original text “I have a white book.” is inputted. The parsing following the morphological analysis for breaking down the text into words creates a phrase structure tree such as the one shown in FIG. 6, by using given phrase structure rules. In FIG. 6, S stands for a sentence, VP for a verbal phrase, NP for a noun phrase, N for a noun, PRO for a pronoun, V for a verb, DET for a determiner (determinative), and ADJ for an adjective. Well-known parsing algorithms for creating such phrase structure trees include the CYK algorithm and chart parsing. For more information on these algorithms, refer, for example, to Hozumi Tanaka (chief editor), “Natural Language Processing and Its Applications”, Institute of Electronics, Information and Communication Engineers, 1999, pp. 19-30.

If the phrase structure is as simple as that shown in FIG. 6, there is no problem. However, conventional phrase structure rules cannot handle the cases in which phrases have overlapping portions. For example, if there are rules:

static→adjective;

RAM→noun;

card→noun;

static RAM→noun phrase;

RAM card→noun phrase, “static RAM card” would be parsed into either “adjective (static)+noun phrase (RAM card)” or “noun phrase (static RAM)+noun (card)”. Generally, since “adjective+noun phrase” is considered to be more probable than “noun phrase+noun”, the phrase structure “adjective+noun phrase” is adopted and a translation, for example, “seiteki-na RAM kahdo (Japanese)” is outputted eventually.

A similar problem is encountered if there is a coordinate conjunction between words or phrases. For example, the phrase “summer and winter vacation” is parsed into the phrase structure “noun (summer)+noun phrase (winter vacation)” with the coordinate conjunction (and) between them, and thus the final translation “natsu to tohkikyuka (Japanese)” is outputted.

As described above, conventional phrase structure rules cannot handle the cases in which phrases have overlapping portions or there is a coordinate conjunction therebetween. In such cases, some measures need to be taken. One possible means involves registering each phrase consisting of three or more words, such as those described above, as an entry in a dictionary. However, there will be a vast number of such phrases and it is practically impossible to register all of them.

### SUMMARY OF THE INVENTION

Therefore, an object of the present invention is to provide a machine translation system and a machine translation method that can properly translate compound words and parallel expressions that could not be handled heretofore, by synthesizing phrase structure rules during parsing according to the sentence being parsed, as well as to provide a computer-readable program storage medium which stores a program for performing this machine translation method.

Another object of the present invention is to provide a machine translation system and a machine translation method that creates new phrase structure rules based on original phrase structure rules if phrases partially overlap or if there is a coordinate conjunction therebetween, as well as to provide a computer-readable program storage medium which stores a program for performing this machine translation method.

A first aspect of the present invention provides a machine translation system comprising: input means for inputting an original text in a first language to be translated; translation processing means for performing translation processing, including parsing, on the inputted original text and generating a translation in a second language; dictionary storage means for storing various dictionaries for use in said translation processing; and output means for outputting said translation; wherein said translation processing means creates new phrase structure rules by synthesizing related phrase structure rules during said parsing and generates said translation based on said new phrase structure rules.

A second aspect of the present invention provides a machine translation method comprising the steps of: inputting an original text in a first language to be translated; performing translation processing, including parsing, on the inputted original text with reference to a given dictionary to generate a translation in a second language; and outputting said translation; wherein said translation processing step creates new phrase structure rules by synthesizing related phrase structure rules during said parsing and generates said translation based on said new phrase structure rules.

A third aspect of the present invention provides a computer-readable program storage medium which stores a program for performing the machine translation method of the second aspect.

Preferred embodiments of the present invention will be described in detail below with reference to the accompanying drawings.

### BRIEF DESCRIPTION OF THE DRAWINGS

FIG. 1 is a block diagram showing the configuration of the machine translation system according to the present invention;

FIG. 2 is a flowchart showing the general flow of the translation process executed by the machine translation system of FIG. 1;

FIG. 3 is a flowchart showing the flow of the parsing step in the translation process of FIG. 2;

FIG. 4 is a flowchart showing the flow of the overlap synthesis processing step in the parsing of FIG. 3;

FIG. 5 is a flowchart showing the flow of the coordinate synthesis processing step in the parsing of FIG. 3; and

FIG. 6 illustrates a phrase structure tree created in the parsing when the original text “I have a white book.” has been inputted.

### PREFERRED EMBODIMENTS OF THE INVENTION

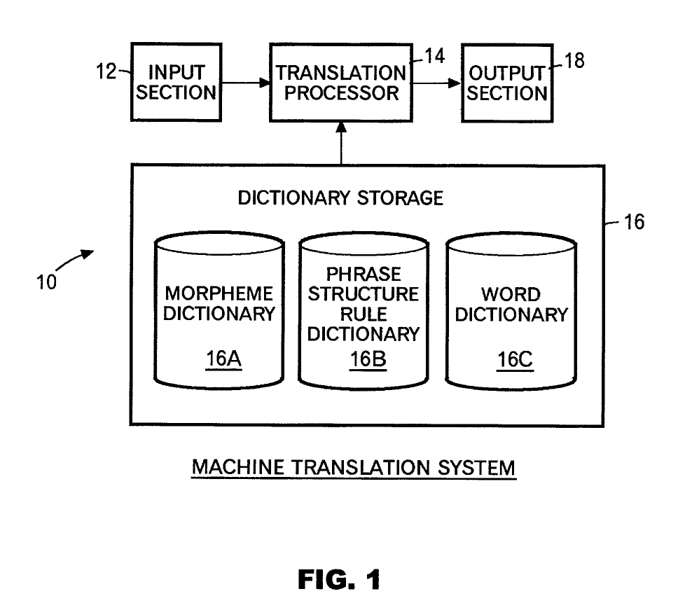

A schematic configuration of the machine translation system 10 according to the present invention is shown in FIG. 1. Although in the embodiments described below, the machine translation system 10 makes translations from English into Japanese, the present invention is not limited thereto. The system 10 comprises an input section 12 for inputting an original text in a first language (English) to be translated; a translation processor 14 for generating a translation in a second language (Japanese) from the inputted original text; a dictionary storage 16 for storing various dictionaries for use by the translation processor 14; and an output section 18 for outputting the translation generated in the translation processor 14.

The input section 12 can be any input mechanism such as a keyboard, character recognition unit, voice recognition unit, or Internet Web page screen as long as it can input original texts to the translation processor 14. Basically, the translation processor 14 may be a conventional machine translation engine. An example of such translation engines is described in K. Takeda “Pattern-Based Context-Free Grammar for Machine Translation,” Proc. of 34th ACL, pp. 144-151, 1996 and K. Takeda “Pattern-Based Machine Translation,” Proc. of 16th Coling, Vol. 2, pp. 1155-1158, 1996. However, as described later, the parsing by the translation processor 14 is different from conventional parsing.

The dictionary storage (e.g., a hard disk drive) 16 stores a plurality of dictionaries for use in translation processing by the translation processor 14. According to this embodiment, the dictionaries stored in the dictionary storage 16 are a morpheme dictionary 16A which stores morpheme information (part of speech and inflection of each word) for use in morphological analysis, phrase structure rule dictionary 16B which stores grammatical rules for use in parsing, and word dictionary 16C for use in morphological generation. The output section 18 is used to present the translations generated by the translation processor 14 to the user and can take any form such as a display, printer, speaker, or the like.

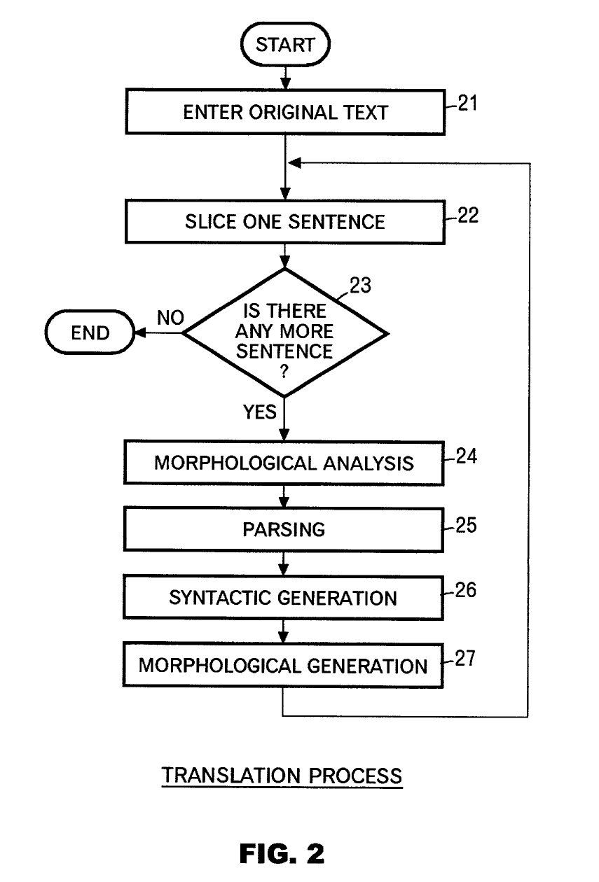

A flow of translation processing in the machine translation system 10 of FIG. 1 is shown in FIG. 2. First in step 21, an original English text is inputted into the input section 12. Then in step 22, the system 10 slices one sentence from the inputted original text. In the case of English, the system 10 determines that a sentence may be delimited or punctuated when (1) a word is immediately followed by a period and the next word begins with a capital letter, or (2) a word is immediately followed by an exclamation mark, colon, or semicolon. However, it should be noted that there are some expressions which satisfy the above condition (1) but do not appear at the end of a sentence, such as “Mr.”. Therefore, the system 10 has such expressions as data, compares the words in the original text with these expressions, and detects the end of a sentence only if there is no match. Also, when there are numeric characters on both sides of a period, a sentence is punctuated at that point if there is a space immediately after the period, but a sentence is continued by regarding the period as a decimal point if there is no such space.

If there is no sentence to be sliced in the sentence slicing step 22, the system 10 takes a path corresponding to “No” after step 23 and ends the translation processing. Otherwise, the system goes to step 24 and performs morphological analysis. In the morphological analysis, the system 10 breaks down the sentence into words and infers parts of speech of the words using the morpheme dictionary 16A stored in the dictionary storage 16. In this embodiment, since the inputted original text is English and each word is delimited by a space, the morphological analysis can be performed relatively easily by giving consideration only to the inflection of each word. However, in the case of a language, such as Japanese, in which words are not written separately, analysis is performed, based on information about the difference of character types (kanji, hiragana, and katakana) and connection between words.

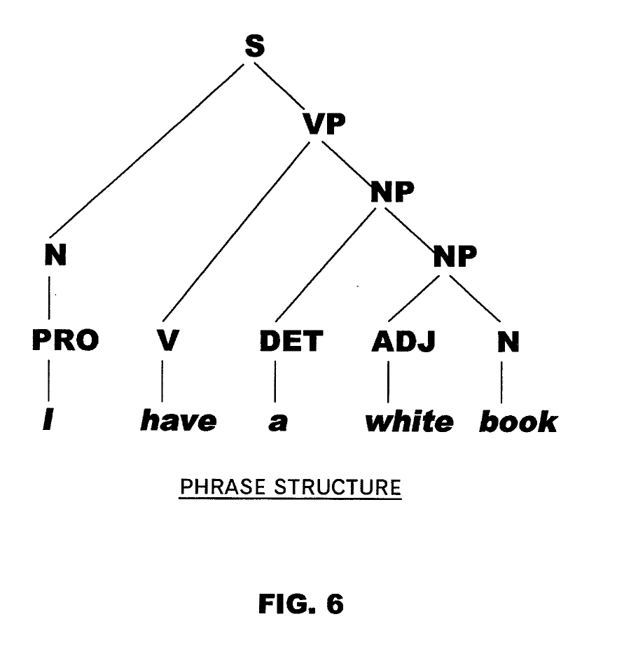

When the morphological analysis is finished, the system 10 goes to parsing in step 25. The parsing eventually organizes a sequence of words into a phrase structure tree such as the one shown in FIG. 6. During this parsing, the system 10 uses its knowledge about what words (phrases) are organized into what phrase. This knowledge is a collection of phrase structure rules, which are stored in the phrase structure rule dictionary 16B in the dictionary storage 16. In the case of English, these rules may be, for example, that combining a verb with a noun object makes a verbal phrase, combining an article with a noun makes a noun phrase, etc. There are also additional rules that combinations of explicitly specified multiple words such as “static RAM” and “the United States” make noun phrases, respectively. The present invention performs parsing using synthesized rules in addition to the conventional phrase structure rules such as those described above. This will be described later. When the entire sentence is finally organized into a single tree, the parsing is finished.

When the parsing is finished, the system 10 goes to syntactic generation in step 26. In the syntactic generation, the system 10 generates a phrase structure tree in the second or target language from the phrase structure in the first or source language. Since each of the phrase structure rules used in the parsing step 25 is provided with a corresponding phrase structure rule of the target language, the phrase structure tree can be generated in the target language by joining them together. For example, the English phrase structure rule “noun phrase+verbal phrase→sentence” corresponds to the Japanese phrase structure rule “noun phrase+ga (Japanese)+verbal phrase→ sentence”, and “the Unites States→noun phrase” corresponds to “amerika-gasshuhkoku (Japanese)→noun phrase”.

When the syntactic generation is finished, the system 10 goes to morphological generation in step 27. In the morphological generation, the system 10 generates a translation from the phrase structure tree in the target language generated in step 26, using the word dictionary 16C. If the phrase structure rules already contain Japanese translation words such as “ga” and “amerika-gasshuhkoku”, they are adopted, as they are, as output translation words. Regarding “ga”, however, it may be changed to “ha”, “mo”, or “shika” during the morphological generation.

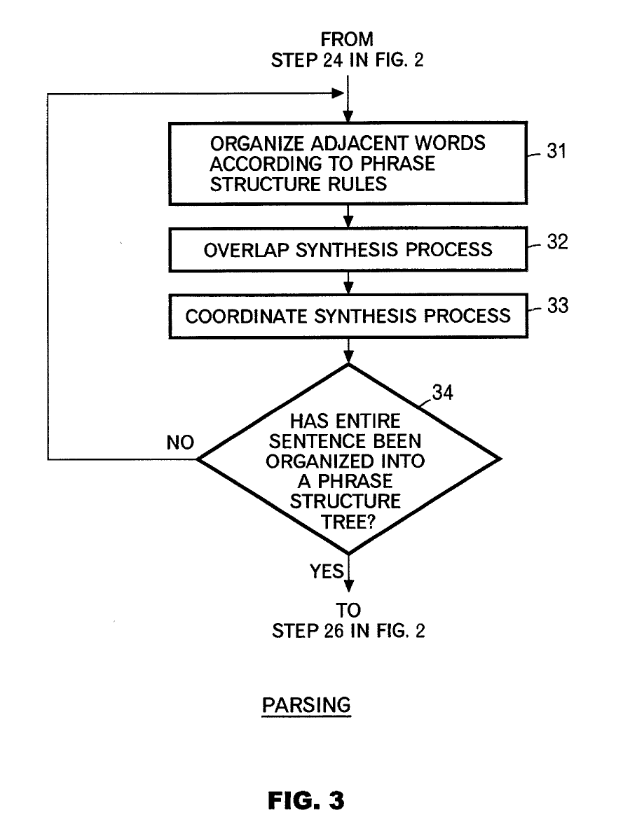

The flow of machine translation has been outlined above in which any known techniques may be used for the steps in FIG. 2 except for the parsing step 25. The parsing process according to the present invention will now be described with reference to FIGS. 3 to 5.

FIG. 3 shows the parsing process in accordance with the present invention. In the conventional parsing, adjacent words are grouped together or organized according to the phrase structure rules contained in the phrase structure rule dictionary 16B (step 31), and the parsing is finished when the entire sentence has been organized into a single phrase structure tree (step 34). According to the present invention, however, two synthesis processes, i.e. overlap synthesis process 32 and coordinate synthesis process 33, are inserted between steps 31 and 34. Although the overlap synthesis process 32 is performed first and then the coordinate synthesis process 33 is performed in the example of FIG. 3, they may be performed in any order.

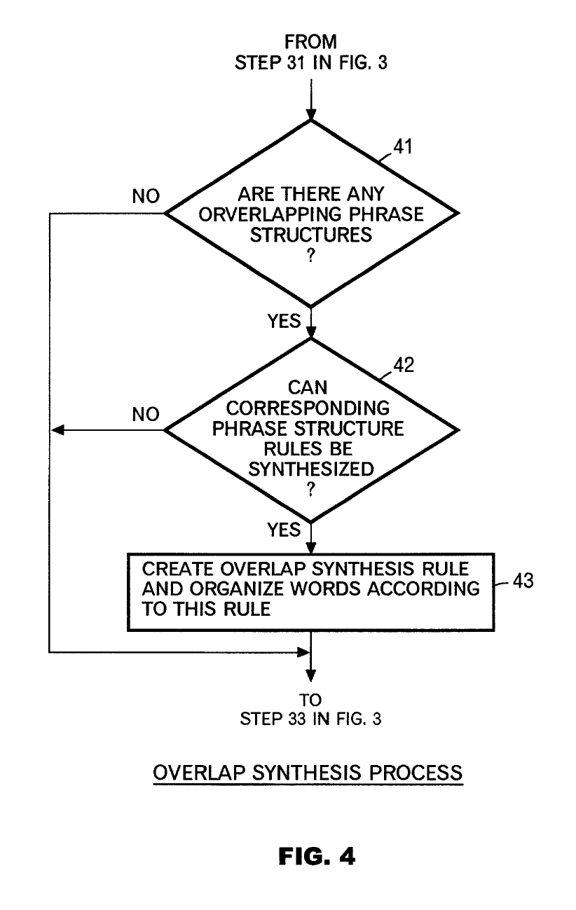

Details of the overlap synthesis process 32 is shown in FIG. 4. In the first step 41, the system 10 checks whether there are overlapping phrase structures, i.e. whether portions of the source language, more specifically, the last word of one phrase structure and the first word of the other phrase structure overlap. In the example of “static RAM card” described above, the phrase structures “static RAM noun phrase” and “RAM card→noun phrase” overlap at the word “RAM”. When such an overlap is detected, the system 10 proceeds from step 41 to step 42. If there are no overlapping phrase structures, the system 10 goes to step 33 in FIG. 3.

If there are overlapping phrase structures, the system 10 checks in step 42 whether corresponding phrase structure rules can be synthesized. This check is performed on the phrase structure rules of both source and target languages. Referring to the example of “static RAM card”, since both phrase structure rules “static RAM→noun phrase” and “RAM card→noun phrase” (stored in the phrase structure rule dictionary 16B of the dictionary storage 16) of the source language are classified as noun phrases and the end of the first phrase structure and the beginning of the second phrase structure contain the same structure (word “RAM” in this case), it is determined that they can be synthesized. Then the system 10 checks corresponding phrase structure rules “sutathikku RAM (Japanese)→noun phrase” and “RAM kahdo (Japanese)→noun phrase” of the target language. Since both are also classified as noun phrases in the rules of the target language, and the end of the first phrase structure and the beginning of the second phrase structure contain the same structure (word “RAM” in this case), it is determined again that they can be synthesized. When the system 10 determines that the phrase structure rules can be synthesized both in the source and target languages, it goes to step 43 where it newly generates a phrase structure rule “static RAM card→noun phrase” of the source language and a corresponding phrase structure rule “sutathikku RAM kahdo→noun phrase” of the target language, and thereby organizes the three words into “static RAM card”.

Besides “static RAM card”, if the system 10 detects, for example, “sequential ID number”, it performs similar processing and generates a phrase structure rule “sequential ID number→noun phrase” of the source language and a phrase structure rule “shiikensharu ID bangoh (Japanese)→noun phrase” of the target language by the overlap synthesis. In the conventional parsing which does not carry out the overlap synthesis, “sequential ID number” is parsed into “sequential” and “ID number”, resulting in the translation “hikituzuite okoru ID bangoh (Japanese)”.

In this way, the overlap synthesis process synthesizes phrase structure rules in both the source and target languages in which the end of one phrase structure rule coincides with the beginning of the other phrase structure rule. If there is no such coincidence, the system does not carry out any synthesis.

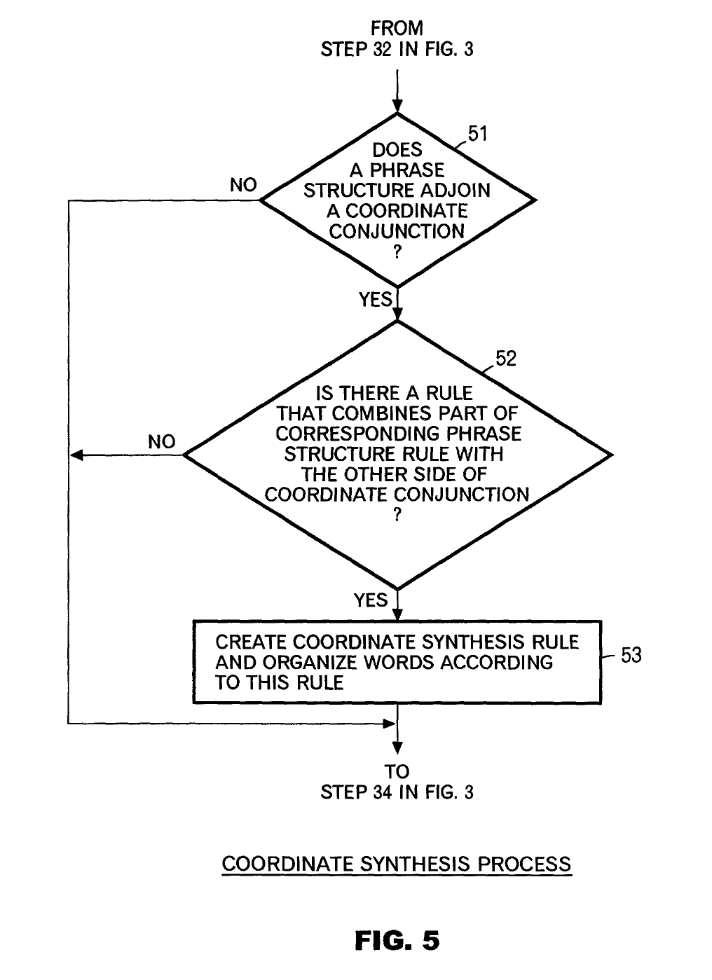

Details of the coordinate synthesis process 33 is shown in FIG. 5. In the first step 51, the system 10 checks whether a phrase structure adjoins a coordinate conjunction (and, or, as well as, etc.). The example “summer and winter vacation” described above satisfies this condition because there exist the phrase structure rule “winter vacation→ noun phrase” and the coordinate conjunction “and” adjacent to (before) it. If the sliced sentence does not contain any phrase structure that satisfies this condition, the system 10 goes to step 34 in FIG. 3.

If there is a phrase structure that satisfies the condition of step 51, the system 10 checks in step 52 whether the phrase structure rule dictionary 16B contains a phrase structure rule that combines part of the corresponding phrase structure rule (for example, “winter vacation→noun phrase”) with the other side of the coordinate conjunction (in this case, “summer” before “and”). In this example, the system 10 checks whether the phrase structure rule dictionary 16B contains a phrase structure rule “summer vacation→ noun phrase”. If the phrase structure rule exists, the system 10 goes to step 53. Otherwise, it goes to step 34 in FIG. 3.

In the last step 53, the system 10 newly generates a phrase structure rule “summer and winter vacation→noun phrase” of the source language and a corresponding phrase structure rule “kaki-kyuhka (Japanese) and tohki-kyuhka (Japanese)→noun phrase” of the target language by the coordinate synthesis, thereby organizing the four words “summer and winter vacation”. The word “and” in the phrase structure rule of the target language will be replaced by the Japanese word “to” contained in the word dictionary 16C during the last morphological generation.

To give another example of the coordinate synthesis, when a text “in plain language or great detail” is to be translated while there exist phrase structure rules “in plain language→adverb phrase” and “in great detail→adverb phrase” of the source language and corresponding phrase structure rules “wakari-yasui kotoba-de (Japanese)→ adverb phrase” and “totemo shousai-ni (Japanese)→adverb phrase” of the target language, the phrase “in plain language” located immediately before the coordinate conjunction “or” matches the rule, and the system 10, therefore, checks in step 52 whether there exist rules “in great detail” and “in plain great detail” obtained by attaching “in” and “in plain” to the phrase “great detail” located on the other side of the coordinate conjunction. In this example, the former rule “in great detail” exists, and the system 10, therefore, eventually obtains a phrase structure rule “in plain language or great detail →adverb phrase” of the source language and a phrase structure rule “wakari-yasui kotoba-de (Japanese) or totemo shousai-ni (Japanese)→adverb phrase” of the target language. This “or” in the latter phrase structure rule will be replaced by the equivalent Japanese term “aruiwa” contained in the word dictionary 16C in the morphological generation, as described above. In the conventional parsing that does not use the coordinate synthesis, the text is parsed into “in ((plain language) coordinate conjunction (great detail))” and translated into “wakari-yasui kotoba aruiwa subarashii shousai-de (Japanese)”.

In this way, in the coordinate synthesis process, if a phrase structure rule matches a phrase either before or after a coordinate conjunction, the system 10 adds part of the phrase structure rule to the other side of the coordinate conjunction, and checks for a matching phrase structure rule. If there is a matching phrase structure rule, the system 10 newly creates a phrase structure rule joined by the coordinate conjunction.

The program for executing the flows shown in FIGS. 2 to 5 can be stored in a computer-readable storage medium such as a hard disk, floppy disk, CD-ROM, or the like. Such a storage medium is also included within the scope of the present invention.

The preferred embodiments of the present invention have been described above with reference to the drawings, but the present invention is not limited to the above described embodiments and it will be apparent to those skilled in the art that various changes and modifications can be made within the scope of the appended claims.

1. A machine translation system comprising: input means for inputting an original text in a first language to be translated; translation processing means for performing translation processing, including parsing, on the inputted original text to generate a translated text in a second language; dictionary storage means for storing various dictionaries for use in said translation processing; and output means for outputting said translated text, wherein said translation processing means creates new phrase structure rules by synthesizing related phrase structure rules during said parsing and generates said translation based on said new phrase structure rules.

2. The machine translation system according to claim 1, wherein said related phrase structure rules contain an overlapping word.

3. The machine translation system according to claim 2, wherein two phrase structure rules of said first language and said second language are synthesized if the beginning of one of the phrase structure rules of said first language coincides with the end of the other phrase structure rule and if the beginning of one of the corresponding phrase structure rules of said second language coincides with the end of the other phrase structure rule.

4. The machine translation system according to claim 1, wherein said related phrase structure rules are accompanied by a coordinate conjunction.

5. The machine translation system according to claim 4, wherein if a rule matches either side of the coordinate conjunction, a part of the rule is added to the other side of the coordinate conjunction to check for a matching rule, and if there exists said matching rule, a rule joined by the coordinate conjunction is newly created.

6. A machine translation method comprising the steps of: inputting an original text in a first language to be translated; performing translation processing, including parsing, on the inputted original text with reference to a given dictionary to generate a translation in a second language; and outputting said translation, wherein said translation processing step creates new phrase structure rules by synthesizing related phrase structure rules during said parsing and generates said translation based on said new phrase structure rules.

7. The machine translation method according to claim 6, wherein said related phrase structure rules contain an overlapping word.

8. The machine translation method according to claim 7, wherein two phrase structure rules of said first language and said second language are synthesized if the beginning of one of the phrase structure rules of said first language coincides with the end of the other phrase structure rule and if the beginning of one of the corresponding phrase structure rules of said second language coincides with the end of the other phrase structure rule.

9. The machine translation method according to claim 6, wherein said related phrase structure rules are accompanied by a coordinate conjunction.

10. The machine translation method according to claim 9, wherein if a rule matches either side of the coordinate conjunction, a part of the rule is added to the other side of the coordinate conjunction to check for a matching rule, and if there exists said matching rule, a rule joined by the coordinate conjunction is newly created.

11. A computer-readable program storage medium which stores a program for executing a machine translation method comprising the steps of: inputting an original text in a first language to be translated; performing translation processing, including parsing, on the inputted original text with reference to a given dictionary to generate a translation in a second language; and outputting said translation, wherein said translation processing step creates new phrase structure rules by synthesizing related phrase structure rules during said parsing and generates said translation based on said new phrase structure rules.

12. The computer-readable program storage medium according to claim 11, wherein said related phrase structure rules contain an overlapping word.

13. The computer-readable program storage medium according to claim 12, wherein two phrase structure rules of said first language and said second language are synthesized if the beginning of one of the phrase structure rules of said first language coincides with the end of the other phrase structure rule and if the beginning of one of the corresponding phrase structure rules of said second language coincides with the end of the other phrase structure rule.

14. The computer-readable program storage medium according to claim 11, wherein said related phrase structure rules are accompanied by a coordinate conjunction.

15. The computer-readable program storage medium according to claim 14, wherein if a rule matches either side of the coordinate conjunction, a part of the rule is added to the other side of the coordinate conjunction to check for a matching rule, and if there exists said matching rule, a rule joined by the coordinate conjunction is newly created.
